(19) United States
(12) Patent Application Publication
(10) Pub. No.: US 2026/0005886 A1
(43) Pub. Date: Jan. 1, 2026

(54) PROVIDING ACCOMMODATIONS DURING ONLINE COMMUNICATION SESSIONS

(71) Applicant: Cisco Technology, Inc., San Jose, CA (US)

(72) Inventor: Lan Betty Ngoc Mai, Shoreline, WA (US)

(21) Appl. No.: 18/756,722

(22) Filed: Jun. 27, 2024

(51) Int. Cl. H04L 12/18

(52) U.S. Cl. CPC H04L 12/1818; H04L 12/1822

(57) ABSTRACT

A meeting server provides, to one or more participants of an online meeting, an invitation to join the online meeting. The invitation including an option to request one or more accommodations for the online meeting. The meeting server obtains, from a participant of the one or more participants, a request for an accommodation, of the one or more accommodations, during the online meeting. The meeting server performs one or more actions associated with the request for the accommodation.

### TECHNICAL FIELD

The present disclosure relates to online communication sessions.

### BACKGROUND

People with disabilities or who require certain accommodations may experience barriers when trying to join or participate in an online meeting or communication session, in part due to lack of planning on behalf of the meeting host. In many cases, the attendees are unable to adjust the meeting experience based on their needs and they need to rely on communicating with the host directly to resolve the issue, which may cause uncomfortable interactions with the host. To respect the privacy of a user and provide accommodations to a user, there is a need to inform a host of a user's accessibility needs without divulging the identity of the user.

### BRIEF DESCRIPTION OF THE DRAWINGS

FIG. 1 is a block diagram of a system configured to receive accommodation requests and provide accommodations to participants of an online meeting, according to an example embodiment.

FIG. 2 is a diagram illustrating options for requesting accommodations for an online meeting, according to an example embodiment.

FIG. 3 is a diagram illustrating a menu of accessibility options at a user device, according to an example embodiment.

FIG. 4 is a signal flow diagram illustrating providing accommodations to a user when the user joins an online meeting, according to an example embodiment.

FIG. 5 is a flow diagram illustrating a method of performing one or more actions in response to a request for an accommodation from a participant of an online meeting, according to an example embodiment.

FIG. 6 is a hardware diagram of a computer device that may be configured to perform the user device features involved in performing actions based on an accommodation request from a participant of an online meeting, according to an example embodiment.

FIG. 7 is a hardware diagram of a computer device that may be configured to perform the meeting server features involved in performing actions based on an accommodation request from a participant of an online meeting, according to an example embodiment.

### DETAILED DESCRIPTION

### Overview

In one embodiment, a computer-implemented method is provided for performing one or more actions in response to a request for an accommodation from a participant of an online meeting. The method includes providing, to one or more participants of an online meeting, an invitation to join the online meeting. The invitation includes an option to request one or more accommodations for the online meeting. The method includes obtaining, from a participant of the one or more participants, a request for an accommodation, of the one or more accommodations, during the online meeting, and performing one or more actions associated with the request for the accommodation.

### EXAMPLE EMBODIMENTS

Barriers frequently exist for people with disabilities or people who require accommodations to attend online meetings or communication sessions. These barriers may include, for example, a host of the meeting not providing a meeting agenda or slide deck before the meeting, the host not providing interpretation options to participants, the host not having closed captions enabled, or the host presenting video or a video background that is “flashy” or distracting. These barriers or issues may occur even if the meeting application is considered to be fully accessible. Many meeting hosts do not provide accommodations for people with disabilities or do not realize that it is possible to improve an online meeting experience for people with disabilities. Instead, when participants do not receive accommodations, the blame is oftentimes placed on the meeting application or vendor.

In current systems, a participant is unable to request accommodations without involving the host of the online meeting in the request. In other words, the participant may be unable to select an option on the participant's device that, for example, closed captions be provided or that a meeting invitation be sent to an interpreter. Instead, the participant has to reach out to the host of the online meeting and the host provides for the accommodation request. This may be uncomfortable for a participant who wishes to maintain anonymous. In addition, the participant would need to rely on the host to perform the required actions to provide the accommodation. If the host does not perform the required actions, the participant is unable to fully participate in the meeting.

Presented herein are techniques for allowing a participant to select requested accommodations for an online meeting. According to embodiments described herein, a meeting invitation sent to participants may include an option for requesting accommodations for an online meeting. A participant may select one or more accommodations for the online meeting and the accommodation request may be sent to a meeting server. The meeting server may transmit an indication of the accommodation request to a host of the meeting. In some embodiments, the accommodation request may not include the name or personal information associated the participant, ensuring anonymity for the participant.

The meeting server may take actions to provide for the accommodation request. In some embodiments, the meeting server may confirm the accommodation request with the participant and provide a link to the participant for accessing the online meeting. When the participant selects the link, the participant may join the meeting with features or settings enabled to address the accommodation request. For example, if the participant requested that closed captioning be provided during the online meeting, when the participant selects the link, the closed captioning is enabled for the participant by default.

Thus, present embodiments improve the technical field of online meetings by providing participants with an option to request accommodations for an online meeting in a meeting invite. Present embodiments therefore increase the efficiency of online meetings by eliminating or minimizing the need for a participant to communicate with a host of an online meeting to provide accommodations to the participant. Thus, present embodiments provide the practical application of an online meeting system that receives a request for accommodations from a participant of an online meeting and automatically performs actions to provide the accommodations to the participant during the online meeting.

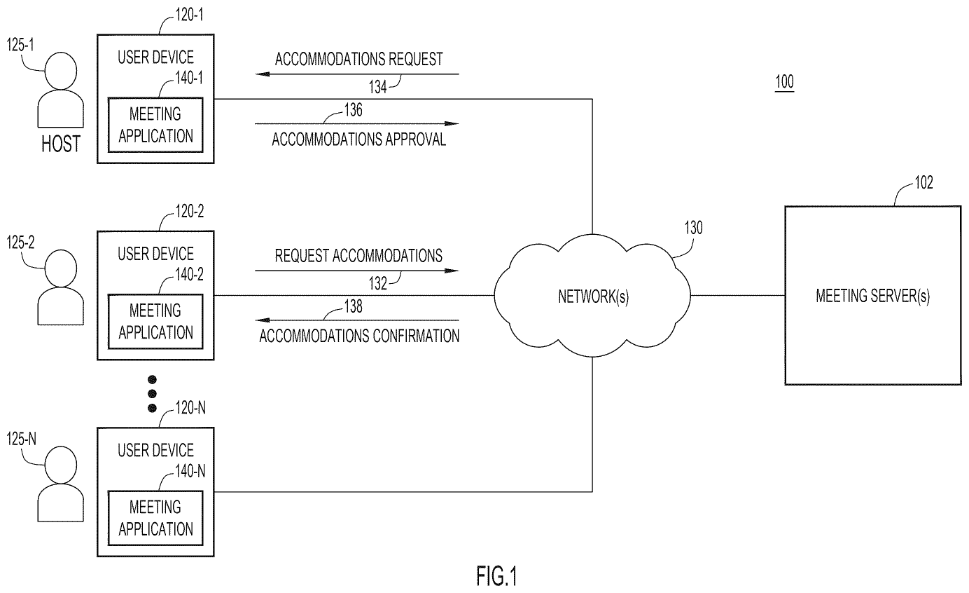

Reference is first made to FIG. 1. FIG. 1 shows a block diagram of a system 100 that is configured to receive requests for accommodations from participants of online meetings and perform actions to provide adjustments for the participants during the online meetings based on the accommodation requests. The system 100 includes one or more meeting server(s) 102 and a plurality of user devices 120-1, 120-2, . . . , 120-N that communicate with the meeting server(s) 102 via one or more networks 130. Each user device 120-1 to 120-N is associated with a user 125-1, 125-2, . . . , 125-N. The meeting server(s) 102 is configured to provide an online meeting service for hosting a communication session among user devices 120-1 to 120-N.

Each of user devices 120-1 to 120-N may be a tablet, laptop computer, desktop computer, Smartphone, virtual desktop client, virtual whiteboard, or any user device now known or hereinafter developed. User devices 120-1 to 120-N may have a dedicated physical keyboard or touch-screen capabilities to provide a virtual on-screen keyboard to enter text. User devices 120-1 to 120-N have the capability to send and receive electronic communications (e.g., emails, chats, messaging communications received via a messaging application or messaging web-service, etc.). For example, users 125-1 to 125-N may use user devices 120-1 to 120-N to send electronic communications (e.g., associated with an accommodation for an online meeting) to and receive electronic communications from meeting server(s) 102.

Meeting applications 140-1 to 140-N may be executed by user devices 120-1 to 120-N to provide communication to the meeting server(s) 102 and control user participation in an online meeting that is supported by the meeting server(s) 102. The meeting server(s) 102 and the meeting applications 140-1 to 140-N are configured to support requests for accommodations during an online meeting. In some embodiments, a user device 120-1 to 120-N may communicate with the meeting server(s) 102 without a meeting application being installed on the user device. For example, a user device 120-1 to 120-N may send an accommodation request to meeting server(s) 102 without using a meeting application 140-1 to 140-N.

In the example illustrated in FIG. 1, user 125-1 is a host on an online meeting and may schedule the online meeting. For example, user 125-1 may create a meeting invite and, in conjunction with meeting application 140-1 and meeting server(s) 102, transmit the meeting invite to users 125-2 to 125-N. In other embodiments, a different user may create and transmit the meeting invite. The meeting invite may include a meeting invite link or a registration invite. According to some embodiments, the landing page of the meeting invite may include an option to allow a user to request accommodations for the online meeting. Common accommodations may include, for example, closed captioning, translation, image descriptions, reduced use notifications/reactions, interpreter requests, meeting content (e.g., files, videos, links) being provided before the meeting, reduced video usage, etc.

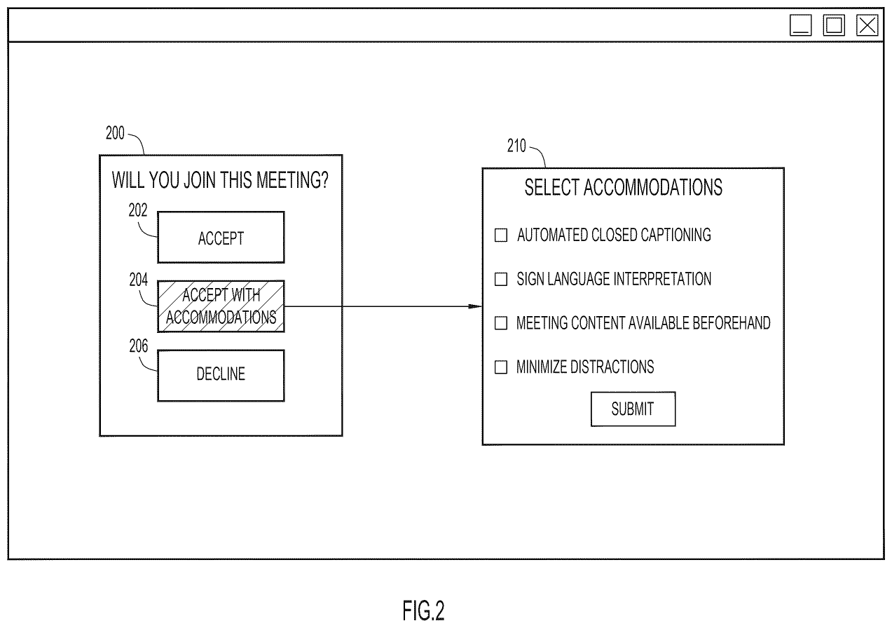

Reference is now made to FIG. 2. FIG. 2 illustrates an example of a portion of a meeting invite 200 that may be presented to an invited meeting participant, such as in an email, instant message, text message, etc. The portion of the meeting invite 200 includes an accept option 202 to accept the invitation to attend the meeting, an accept with accommodations option 204 to accept the invitation and request accommodations for the online meeting, and a decline option 206 to decline the invitation to the online meeting.

As illustrated in FIG. 2, when a user selects the accept with accommodations option 204, the user may be presented with a menu 210 to select accommodations. In the example illustrated in FIG. 2, menu 210 includes the accommodation options of automated closed captioning, sign language interpretation, having meeting content available beforehand, and minimizing distractions. Other accommodations options not illustrated in FIG. 2 may be provided. As one example, menu 210 may include an option to have the online meeting translated into a different language or other options.

As another example, in the case of a participant who requires an American Sign Language (ASL) interpreter, a user interface may be presented to allow a user to input the name, email, phone number, etc., of their preferred sign language interpreter. The information associated with the preferred sign language interpreter may be provided to the meeting server(s) 102 and the host and the sign language interpreter may be sent a meeting invite for the online meeting. In this case, the host may enable and assign the sign language interpreter the sign language interpreter role. During this exchange, the identity of the participant requesting the sign language interpretation accommodation may remain private or unknown, which may be preferable for some users.

Some of the available accommodations illustrated in menu 210 are accommodations that may not normally be available in basic meeting options. For example, if the user 125-2 is visually impaired and would like to review meeting material or content in advance of the meeting, the user 125-2 may use menu 210 to request that meeting content (e.g., slides, meeting agenda, etc.) be provided prior to the meeting. Receiving meeting materials, such as a slide deck, prior to the meeting may allow a user to review the materials using their own assistive technology, such as a screen reader, so the user can better follow along when the slide deck is being shared during the meeting. In this way, the user may not have to make a decision as to whether to listen to the speaker or listen to the screen reader reading the shared content while the meeting is occurring.

Returning to FIG. 1, user 125-2 may receive the meeting invitation and user 125-2 may request accommodations for the online meeting. At 132, user device 120-2 may transmit the accommodations request to meeting server(s) 102. When meeting server(s) 102 receives the accommodations request, meeting server(s) 102 may save the accommodations request information in a data store. If user 125-2 has an account or profile associated with a meeting service associated with the meeting server(s) 102, meeting server(s) 102 may associate the accommodations request with the account or profile. For example, if the user 125-2 is signed into the user's account, the information may be saved in the user's accessibility profile. If the user does not have a profile associated with the meeting server or the user is not signed into the user's account, meeting server(s) 102 may save the information using with a code or identifier that may be provided to the user when the accommodations request has been approved. The code or identifier may be used by the user 125-2 when signing into the meeting to receive services associated with the requested accommodation during the online meeting. In this way, a participant who is a guest and does not have an account associated with the meeting service may still request and receive accommodations to optimize the online meeting experience.

At 134, the accommodations request may be transmitted to the host (e.g., user 125-1) of the online meeting. In some embodiments, the request may be transmitted without the name or any personal information associated with user 125-2 to protect the privacy of the user. Transmitting the accommodations request to the host helps the host prepare for the online meeting and perform any actions necessary to help with the accommodation request. For example, if the participant requested that meeting materials be provided prior to the online meeting, providing the accommodation request to the host allows the host time to provide the meeting content to the user before the start of the online meeting.

The host may approve the accommodations request and, at 136, user device 120-1 may transmit the accommodations approval to meeting server(s) 102. At 138, meeting server(s) 102 confirms the accommodations with user 125-2. In addition, meeting server(s) 102 may provide information to user 125-2 to use to join the online meeting with setting or features associated with the accommodations request enabled. For example, meeting server(s) 102 may provide user 125-2 a link to access the meeting with the settings or features enabled, the code used when saving the accommodations request information, or other information.

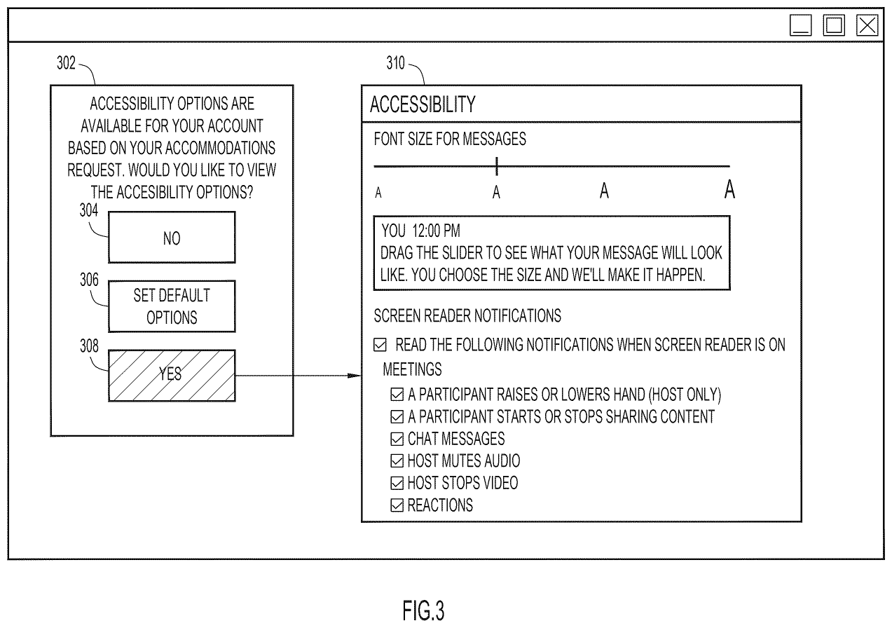

In some embodiments, meeting server(s) 102 may additionally provide information to the user 125-2 regarding settings adjustments that may be made at user device 120-2 based on the accommodations request. Reference is now made to FIG. 3. FIG. 3 illustrates a prompt 302 that may be transmitted to a user with information associated with settings adjustments that may be made at user device 120-2 (e.g., using meeting application 140-2) to improve a meeting experience based on the accommodations request provided by user 125-2.

As illustrated in FIG. 3, meeting server(s) 102 may transmit prompt 302 to user 125-2 indicating that accessibility options for the user are available at the client-side (e.g., using meeting application 140-2) that may improve the online meeting experience based on the request for accommodations. For example, the user may access and select accessibility options associated with the user's account that may optimize online meetings for the user. The user may be unaware of the accessibility options or unsure how to access the accessibility options, so transmitting the prompt 302 to the user may notify the user of the additional accessibility options or help the user in locating the additional accessibility options.

As illustrated in FIG. 3, prompt 302 asks the user whether the user would like to view the accessibility options. The prompt 302 includes a “no” option 304, a “set default options” option 306, and a “yes” option 308. If the user selects the “no” option 304, the accessibility options are not presented to the user. If the user selects the “yes” option 308, accessibility options menu 310 may automatically be presented to the user. Accessibility options menu 310 illustrates exemplary options and additional or different accessibility options may be available for selection by the user. The accessibility options menu 310 may additionally be opened by the user by navigating to the accessibility options menu using the meeting application on the user's device. The accessibility options menu 310 includes options that the user may set up in advance of an online meeting to optimize the user's experience in the online meeting.

The accessibility options menu 310 illustrated in FIG. 3 may be associated with an accommodations request for a user who is blind or who has limited sight. In this example, the user may use a screen reader application to read text on the screen to the user and notify the user of other actions that may occur during the meeting (e.g., participant reactions, a host muting audio, a host sharing content, etc.). By selecting different options on accessibility options menu 310, the user may set a size of the text on the screen as well as choose which notifications will be read to the user during the online meeting. Other options may be displayed for users with different accommodations requests. For example, a user who is deaf or has hearing challenges may be presented with accessibility options for closed captioning or enhanced volume levels. In addition, the user may be presented with an accessibility options menu with different tabs associated with different accessibility options. In this way, the user may choose options associated with different accommodations requests.

By choosing “set default options” option 306, default options may be selected for the user based on the accommodations request. For example, having a screen reader alert the user every time a participant reacts or raises a hand may be distracting to the user. The default options may de-select these options so the user is alerted fewer times during an online meeting. In one embodiment, when the “set default options” option 306 is selected, accessibility options menu 310 is displayed with the default options selected for the accommodations request. In another embodiment, the default options may be selected for the online meeting without displaying the accessibility options menu 310. In some embodiments, the default accessibility settings may be chosen, for example, based on common accessibility settings chosen by other participants with the same or similar accommodation requests.

Returning to FIG. 1, at the time of the online meeting, the meeting host (e.g., user 125-1) may be reminded of the accommodations request. In some embodiments, if the host's license allows it, the online meeting may already be enabled for all required items (e.g., closed caption is automatically available, files are automatically shared, interpretation has been enabled and assigned). When the user 125-2 selects the link or enters the code previously transmitted to the user by the meeting server(s), the user 125-2 may join the meeting with the features or settings associated with the accommodations request enabled for the user 125-2. For example, the user 125-2 may be provided closed captioning that is on by default, meeting files that are prominently displayed, interpretation control (including the ability to subscribe to an interpreter chosen by the user), reactions or other distracting in-meeting notifications being disabled or reduced for the user 125-2, or other accommodations.

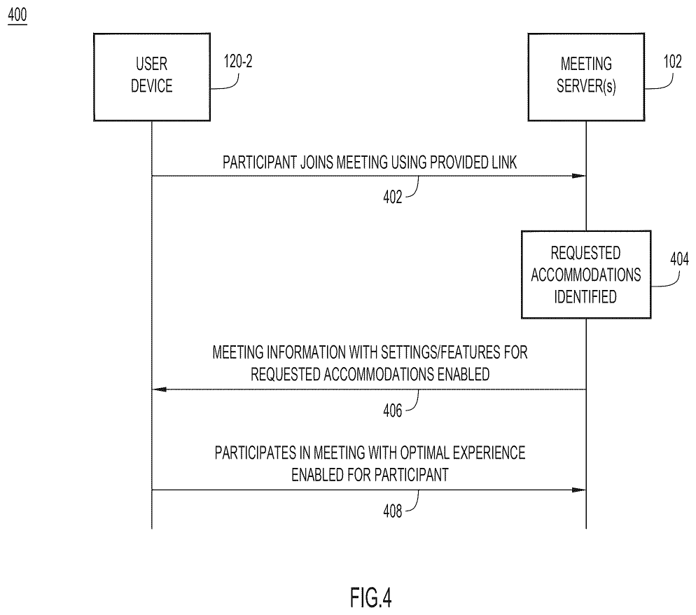

Reference is now made to FIG. 4. FIG. 4 is a signal flow diagram illustrating a method 400 of enabling settings or features associated with an accommodation request for an online meeting. Method 400 may be performed by user device 120-2 in conjunction with meeting server(s) 102.

At 402, user 125-2 joins the online meeting using a provided link. For example, user 125-2 may select a link on user device 120-2 and a join request may be transmitted to meeting server(s) 102. The link may include information (e.g., a code or identifier) associated with an accommodations request that was previously made by user 125-2. At 404, meeting server(s) 102 may identify the requested accommodations. As described above, the meeting server(s) 102 may have stored information associated with the accommodation request with the code or identifier that is associated with the link provided to the user 125-2. Meeting server(s) 102 may use the code or identifier associated with the link to identify the accommodation request.

At 406, meeting server(s) 102 may transmit meeting information associated with the online meeting to user device 120-2 with settings or features enabled automatically for the accommodations that were requested. For example, closed captioning may be enabled for the user 125-2, meeting files may be prominently displayed for user 125-2, reactions and other distracting in-meeting notifications may have been disabled or reduced for user 125-2, or other features/settings may have been enabled based on the accommodation request. At 408, user 125-2 participates in the meeting with the optimal experience enabled for the participant. User device 120-2 and meeting server(s) 102 exchange information associated with the online meeting with the features/settings enabled for the user 125-2 to allow the user 125-2 to participate in the meeting with any needs accommodated. In this way, the user 125-2 may optimally experience the online meeting with any assistive technology or other needs addressed automatically and without relying on a meeting host to set up the accommodations for the user.

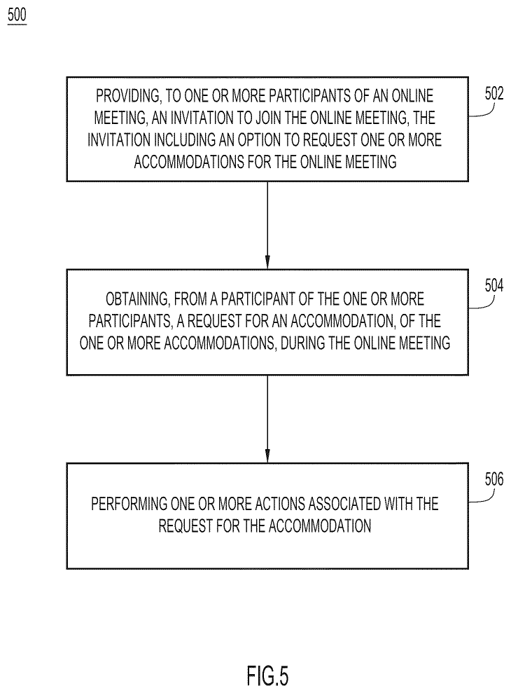

Reference is now made to FIG. 5. FIG. 5 is a flow chart illustrating a method 500 of performing one or more actions based on an accommodations request from a participant of an online meeting.

At 502, one or more participants of an online meeting are provided an invitation to join the online meeting. The invitation includes an option to request one or more accommodations for the online meeting. For example, a meeting server may provide an invitation to join an online meeting to one or more participants. The invitation may include options to accept the invitation, decline the invitation, or accept the invitation with accommodations.

At 504, a request for an accommodation, of the one or more accommodations, during the online meeting is obtained from a participant of the one or more participants. For example, the participant may select the option to accept the invitation with accommodations. The participant may select an accommodation from a menu of accommodations to request the accommodation during the online meeting. The request for the accommodation may be transmitted to the meeting server. The request for the accommodation may include, for example, a request for closed captioning, a request for sign language (or other language) interpretation, a request to make meeting content available prior to the meeting, a request to minimize distractions (e.g., by buffering or obscuring some video content, by minimizing actions during the online meeting that are alerted to the participant by a screen reader, etc.), or other accommodations.

At 506, one or more actions associated with the request for the accommodation may be performed. For example, the meeting server may transmit the request for the accommodation to a host of the online meeting and store the request for the accommodation with a code or an identifier associated with participant. If the participant has an account or profile associated with the meeting service, the meeting server may store the request for the accommodation in the user's profile. The meeting server may transmit a link and/or the code/identifier to the participant. When it is time for the online meeting, the participant may select the link or join the meeting and enter the code/identifier and features or settings associated with the request for the accommodation may automatically be enabled for the participant.

The features of method 500 enhance meeting experiences for users who require accommodations during the online meeting. The techniques allow a participant to communicate with the host and/or meeting server to request accommodations while being able to maintain their privacy and dignity. When the participant joins the meeting, the optimal experience will automatically be enabled for the participant with any assistive technology or other needs addressed.

The embodiments described herein further allow a participant that does not have a meeting application installed on their user device or an account/profile with the meeting service to automatically receive accommodations without having to enable features while the meeting is ongoing. For example, if a participant that does not have a meeting application installed on their user device or an account/profile with the meeting service requests an accommodation to prevent being triggered by videos with flashy content, the meeting server may store this information (e.g., with a code or identifier that is provided to the participant). The meeting server may retrieve the information at the time of the online meeting, and enable features to automatically buffer or obscure video content. In this way, the participant does not have to find and update settings to buffer or obscure the video content while the online meeting is ongoing. This leaves the participant free to experience the meeting without needing to stumble around to find settings, especially if the settings are located in multiple places.

In addition, embodiments described herein help a user with a meeting application installed on their user device and an account/profile with the meeting server to set up settings associated with the accommodation request on their own user device. For example, the meeting server may transmit a message to the participant indicating that client-side settings associated with the accommodations request are available and asking whether the participant would like to view the accessibility options. In this way, the participant may easily access accessibility options for the online meeting and may store chosen accessibility settings for future online meetings.

In one embodiment, the stored chosen accessibility settings may automatically be applied when the participant is participating in future online meetings so the user does not have to apply desired accessibility settings for every meeting. In another embodiment, the user may select a “use stored accessibility settings” option from a menu (e.g., when the user accepts a meeting invite) and the stored accessibility options may be applied for the meeting. In yet another embodiment, the user may associate a type of meeting (e.g., work meeting, meeting with friends, etc.) with the stored the accessibility settings and the user may apply the stored settings to future meetings based on the type of the meeting (e.g., by selecting a menu option when the user accepts the meeting invite, by accessing the stored settings in an accessibility menu, etc.). The stored accessibility options may additionally be accessed prior to a meeting by navigating to the accessibility menu in the user's meeting application and selecting the stored accessibility options for the meeting.

In addition, the participant may choose default accessibility settings based on the accommodations request. In some embodiments, the default accessibility settings may be chosen, for example, based on common accessibility settings chosen by other participants with the same or similar accommodation requests.

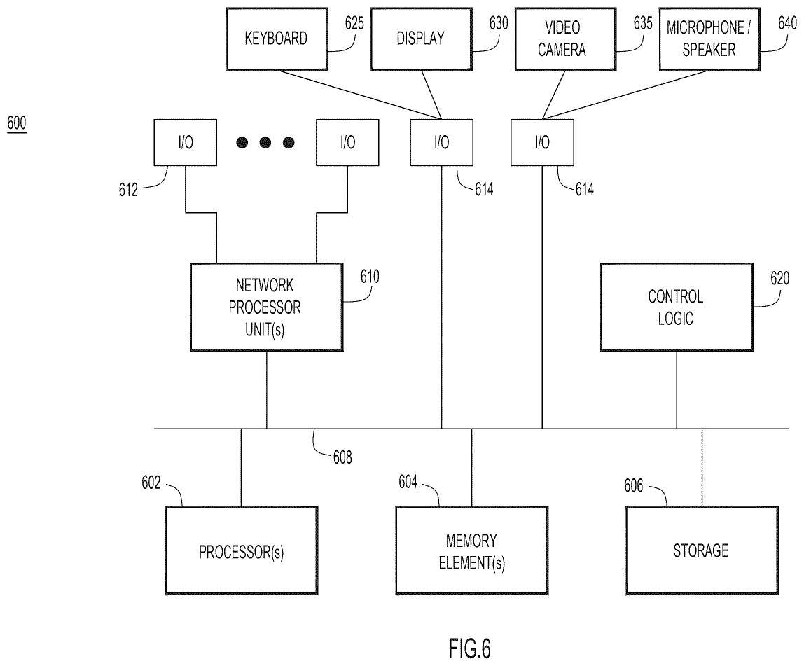

Referring to FIG. 6, FIG. 6 illustrates a hardware block diagram of a computing/computer device 600 that may perform functions of a user device associated with operations discussed herein in connection with the techniques depicted in FIGS. 1-5. In various embodiments, a computing device, such as computing device 600 or any combination of computing devices 600, may be configured as any devices as discussed for the techniques depicted in connection with FIGS. 1-5 in order to perform operations of the various techniques discussed herein.

In at least one embodiment, the computing device 600 may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa), or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 (wired and/or wireless) to facilitate operations discussed for various embodiments described herein. Examples of wireless communication capabilities include short-range wireless communication (e.g., Bluetooth), wide area wireless communication (e.g., 4G, 5G, etc.). In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to computer device 600. For example, I/O interface(s) 614 may provide a connection to external devices such as a keyboard 625, keypad, a touch screen, and/or any other suitable input and/or output device now known or hereafter developed. This may be the case, in particular, when the computer device 600 serves as a user device described herein. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, such as display 630 shown in FIG. 6, particularly when the computer device 600 serves as a user device as described herein. Display 630 may have touch-screen display capabilities. Additional external devices may include a video camera 635 and microphone/speaker combination 640.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

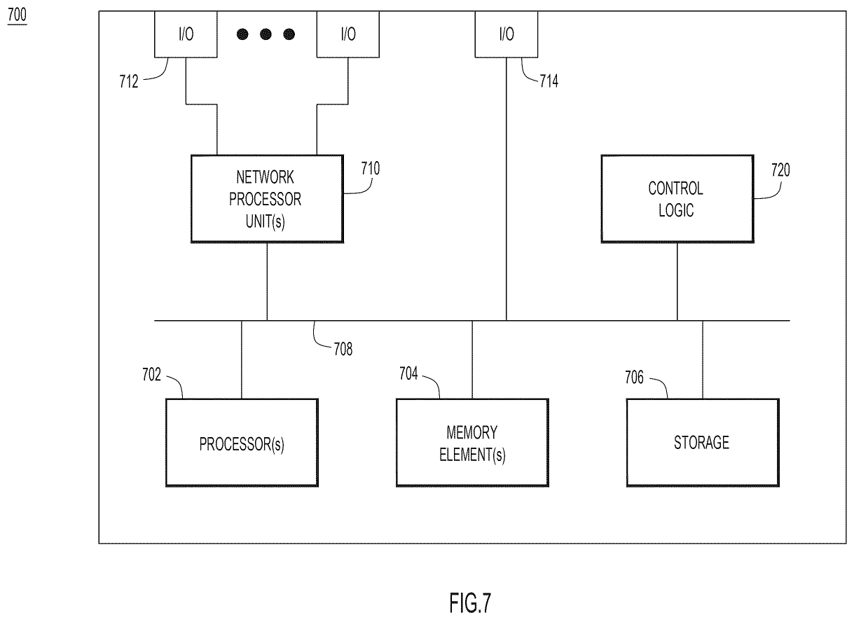

FIG. 7 illustrates a block diagram of a computing device 700 that may perform the functions of the meeting server(s) 102 described herein. The computing device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and application server logic 720. In various embodiments, instructions associated with the application server logic 720 is configured to perform the meeting server operations described herein.

In one form, a computer-implemented method is provided comprising providing, to one or more participants of an online meeting, an invitation to join the online meeting, the invitation including an option to request one or more accommodations for the online meeting; obtaining, from a participant of the one or more participants, a request for an accommodation, of the one or more accommodations, during the online meeting; and performing one or more actions associated with the request for the accommodation.

In one example, the method further includes transmitting the request for the accommodation to a host of the online meeting. In another example, the one or more accommodations for the online meeting include: automated closed captioning for the online meeting, language interpretation for the online meeting, receiving meeting content prior to the online meeting, or buffering or obscuring of particular video content during the online meeting. In another example, performing the one or more actions includes: confirming the request for the accommodation with the participant; and transmitting, to the participant, a link to join the online meeting, wherein selection of the link causes features associated with the request for the accommodation to be enabled for the participant during the online meeting.

In another example, performing the one or more actions includes: enabling closed captioning for the participant, sending the invitation to join the online meeting to an interpreter, sending content associated with the online meeting to the participant prior to the online meeting, or taking actions to buffer or obscure particular video content during the online meeting. In another example, performing the one or more actions includes transmitting, to the participant, information associated with settings to select to configure the online meeting based on a type of the accommodation requested, the settings being associated with a device of the participant. In another example, the information includes an option to select default settings associated with the type of the accommodation.

In another form, an apparatus is provided comprising: a memory; a network interface configured to enable network communication; and a processor, wherein the processor is configured to perform operations including: providing, to one or more participants of an online meeting, an invitation to join the online meeting, the invitation including an option to request one or more accommodations for the online meeting; obtaining, from a participant of the one or more participants, a request for an accommodation, of the one or more accommodations, during the online meeting; and performing one or more actions associated with the request for the accommodation.

In yet another form, one or more non-transitory computer readable storage media encoded with instructions are provided that, when executed by a processor of a technical support system, cause the processor to execute a method including: providing, to one or more participants of an online meeting, an invitation to join the online meeting, the invitation including an option to request one or more accommodations for the online meeting; obtaining, from a participant of the one or more participants, a request for an accommodation, of the one or more accommodations, during the online meeting; and performing one or more actions associated with the request for the accommodation.

### VARIATIONS AND IMPLEMENTATIONS

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
providing, to one or more participants of an online meeting, an invitation to join the online meeting, the invitation including an option to request one or more accommodations for the online meeting;
obtaining, from a participant of the one or more participants, a request for an accommodation, of the one or more accommodations, during the online meeting; and
performing one or more actions associated with the request for the accommodation.

2. The computer-implemented method of claim 1, further comprising:
transmitting the request for the accommodation to a host of the online meeting.

3. The computer-implemented method of claim 1, wherein the one or more accommodations for the online meeting include: automated closed captioning for the online meeting, language interpretation for the online meeting, receiving meeting content prior to the online meeting, or buffering or obscuring of particular video content during the online meeting.

4. The computer-implemented method of claim 1, wherein performing the one or more actions includes:
confirming the request for the accommodation with the participant; and
transmitting, to the participant, a link to join the online meeting, wherein selection of the link causes features associated with the request for the accommodation to be enabled for the participant during the online meeting.

5. The computer-implemented method of claim 1, wherein performing the one or more actions includes: enabling closed captioning for the participant, sending the invitation to join the online meeting to an interpreter, sending content associated with the online meeting to the participant prior to the online meeting, or taking actions to buffer or obscure particular video content during the online meeting.

6. The computer-implemented method of claim 1, wherein performing the one or more actions comprises transmitting, to the participant, information associated with settings to select to configure the online meeting based on a type of the accommodation requested, the settings being associated with a device of the participant.

7. The computer-implemented method of claim 6, wherein the information includes an option to select default settings associated with the type of the accommodation.

8. An apparatus comprising:
a memory;
a network interface configured to enable network communication; and
a processor, wherein the processor is configured to perform operations comprising:
providing, to one or more participants of an online meeting, an invitation to join the online meeting, the invitation including an option to request one or more accommodations for the online meeting;
obtaining, from a participant of the one or more participants, a request for an accommodation, of the one or more accommodations, during the online meeting; and
performing one or more actions associated with the request for the accommodation.

9. The apparatus of claim 8, wherein the processor is configured to perform operations comprising:
transmitting the request for the accommodation to a host of the online meeting.

10. The apparatus of claim 9, wherein the one or more accommodations for the online meeting include: automated closed captioning for the online meeting, language interpretation for the online meeting, receiving meeting content prior to the online meeting, or buffering or obscuring of particular video content during the online meeting.

11. The apparatus of claim 10, wherein, when performing the one or more actions, the processor is further configured to perform operations comprising:
confirming the request for the accommodation with the participant; and
transmitting, to the participant, a link to join the online meeting, wherein selection of the link causes features associated with the request for the accommodation to be enabled for the participant during the online meeting.

12. The apparatus of claim 8, wherein, when performing the one or more actions, the processor is further configured to perform one or more operations comprising:
enabling closed captioning for the participant, sending the invitation to join the online meeting to an interpreter, sending content associated with the online meeting to the participant prior to the online meeting, or taking actions to buffer or obscure particular video content during the online meeting.

13. The apparatus of claim 8, wherein, when performing the one or more actions, the processor is further configured to perform operations comprising:
transmitting, to the participant, information associated with settings to select to configure the online meeting based on a type of the accommodation requested, the settings being associated with a device of the participant.

14. The apparatus of claim 13, wherein the information includes an option to select default settings associated with the type of the accommodation.

15. One or more non-transitory computer readable storage media encoded with instructions that, when executed by a processor of a technical support system, cause the processor to execute a method comprising:
providing, to one or more participants of an online meeting, an invitation to join the online meeting, the invitation including an option to request one or more accommodations for the online meeting;
obtaining, from a participant of the one or more participants, a request for an accommodation, of the one or more accommodations, during the online meeting; and
performing one or more actions associated with the request for the accommodation.

16. The one or more non-transitory computer readable storage media of claim 15, wherein the method further comprises:
transmitting the request for the accommodation to a host of the online meeting.

17. The one or more non-transitory computer readable storage media of claim 15, wherein the one or more accommodations for the online meeting include: automated closed captioning for the online meeting, language interpretation for the online meeting, receiving meeting content prior to the online meeting, or buffering or obscuring of particular video content during the online meeting.

18. The one or more non-transitory computer readable storage media of claim 15, wherein performing the one or more actions includes:
confirming the request for the accommodation with the participant; and
transmitting, to the participant, a link to join the online meeting, wherein selection of the link causes features associated with the request for the accommodation to be enabled for the participant during the online meeting.

19. The one or more non-transitory computer readable storage media of claim 15, wherein performing the one or more actions includes: enabling closed captioning for the participant, sending the invitation to join the online meeting to an interpreter, sending content associated with the online meeting to the participant prior to the online meeting, or taking actions to buffer or obscure particular video content during the online meeting.

20. The one or more non-transitory computer readable storage media of claim 15, wherein performing the one or more actions comprises transmitting, to the participant, information associated with settings to select to configure the online meeting based on a type of the accommodation requested, the settings being associated with a device of the participant.
